(19) United States
(12) Patent Application Publication
(10) Pub. No.: US 2011/0190674 A1
(43) Pub. Date: Aug. 4, 2011

(54) Support Device For The Establishment Of A Controlled Flow Of Blood In A Body Part

(76) Inventors: Flemming Dahl, Albertslund (DK); Henrik Boas Dahl, Esbjerg N (DK)

(21) Appl. No.: 13/059,653

(22) PCT Filed: Aug. 18, 2009
(86) PCT No.: PCT/DK2009/000181

§ 371 Date: Apr. 20, 2011

(30) Foreign Application Priority Data
Aug. 21, 2008 (DK) PA 2008 01137
Mar. 2, 2009 (DK) PA 2009 00268

(51) Int. Cl. A61H 7/00

(52) U.S. Cl. 601/84

(57) ABSTRACT

To achieve a support for sitting or lying individuals who have difficulty in moving, the problems associated with this, such as decubitus, may be remedied by a support device according to the invention, in which a large number of cylinders (4) are arranged, each having a piston and a piston rod of its own which carries a pressure plate (3). When liquid is discharged and liquid is simultaneously supplied to an adjacent cylinder (4), the blood (9) will flow directly from one pressure plate (B) to the adjacent pressure plate (A) and is thereby conveyed through the shortest possible path possible in the body (8). This pattern is repeated for all the pressure plates, and this provides an unprecedentedly effective flow of blood to remedy the distress which is associated with a more or less permanent sitting or lying posture.

The present invention relates to a support device in the form of a seat or a mattress for the establishment of a controlled flow of blood in a body part resting on the support device in which a plurality of vertically movable support elements are disposed, said each support elements being in the form of a pressure plate mounted on a piston rod of a piston in a cylinder, to which a hydraulic liquid is supplied and discharged from the cylinder chamber to raise and lower the pressure plate, respectively.

### THE PRIOR ART

To prevent and treat decubitus, which particularly affects individuals who have to sit or lie more or less passively because of a handicap, it has been attempted to remedy the distress which is associated with this.

The most common treatment consists of the use of pads or supports which are capable of distributing the pressure of the body against the support. This may be done by means of more or less viscous fillers.

The effect, however, is of a “passive” type without any active impact on the body to promote the circulation of blood.

Support devices which adjust to the contours and even out pressure of the body resting on the mattress are also known from WO 01/01822 A1 and DE 29614773 U1. The mattresses described herein each comprise hydraulically interconnected support elements in which pressure (arising from the body resting on the mattress) on one or more of the lowered support elements is transferred to other support elements, which are raised by the hydraulic liquid.

U.S. Pat. No. 5,237,501 A discloses a support device for reducing development of bed sores or pressure ulcers. The support device is constructed of an array of vertical support elements having pressure plates mounted on a piston rod in a cylinder. Each cylinder is preferably controlled pneumatically and receives the driving means, especially air, from a common source via actuators or servo valves on each of cylinders. The cylinders are connected to electrical control means including a microprocessor based control system, which determines the lowering/raising of the independent support elements.

Another support and massaging device is described in DE 3615421 A1.

GB 1 540 336 discloses activation in the support in the form of support members which are alternately raised and lowered. This is said to promote the flow of blood and thereby counteract decubitus, while providing a convenient support of the body.

In practice, however, it has not operated satisfactorily, as the flow of blood is not controlled to a sufficient degree, but solely takes place in that a support is moved up or down, whereby blood is pressed together and flows to the nearest area where a support is lowered. This will mean that the flow of blood becomes arbitrary and irregular and thereby uncomfortable for the individual, in particular those who have already developed decubitus, just as it does not contribute to remedying this.

### THE OBJECT OF THE INVENTION

It is the object of the invention to remedy these defects and drawbacks, and this is achieved according to the invention by a support device wherein the support device comprises a plurality of cylinders which are interconnected hydraulically in sets and wherein the control of distribution of the hydraulic liquid is controlled by a valve with pressure supply of hydraulic liquid and stepwise supply to and discharge of the hydraulic liquid from the individual sets of cylinders such that when one of the sets of pressure plates is lowered an adjacent and previously lowered set of pressure plates (3) is raised (7).

In this surprisingly simple manner, the control is provided by means of a valve which is capable of conveying hydraulic liquid to and from the activated cylinders with a given cycle, an operationally reliable and expedient control is achieved. This results in a flow of blood in the body, which is not an arbitrary seepage or accumulation of blood, but a completely controlled flow from a support point where the support element is raised, and to an adjacent support point whose support element is simultaneously lowered, so as to create a “closed” circulation of blood from the tissue above the cylinder which is raised, to the tissue above an adjacent cylinder which is lowered.

This ensures a completely natural flow of blood and thereby promotes the natural flow of blood in the body to and from the heart. This flow of blood can effectively cure decubitus and may also be a great comfort for individuals who themselves cannot ensure the flow of blood in the body by movement on the support device.

When, as stated in claim 2, the cooperating supports are disposed in close proximity to each other, the blood can easily flow between the points without any form of pressure and thereby without pain.

When, as stated in claim 3, the support device is configured in the form of sets with many support elements, a completely even rhythmic movement of the support elements is achieved, thereby ensuring a completely even flow of blood in the parts of the body which rest on the support device.

When, as stated in claim 4, the individual pressure plates are mounted on the piston rod by means of a snap-like grip, it is ensured that the pressure plate may be mounted easily.

When, as stated in claim 5, a depression is provided on the lower side of the pressure plate, on which a ball-shaped end part on the piston rod may be secured, it is ensured that the pressure plate may be moved and thereby conform to the shape of the body.

When, as stated in claim 6, the extent of the depression is limited and thereby the encirclement of the ball-shaped part on the piston rod, it is ensured that the pressure plate may tilt and thereby easily conform to the various body shapes.

Finally, as stated in claim 7, it is expedient that one or more pressure plates may be removed, e.g. below sores or other injuries on the body which may not be loaded.

### THE DRAWING

An example of a method and an embodiment of a support device according to the invention and its function will be described more fully below with reference to the drawing, in which

FIGS. 1-3 schematically show how two adjacent supports are moved according to the invention,

FIG. 4 shows how a pressure plate, shown in section, is mounted on the end of a piston rod, and

FIG. 5 shows a support device seen from above with a valve, shown in outline, for the control of the hydraulic flows to the individual cylinders.

### DESCRIPTION OF AN EXEMPLARY EMBODIMENT

As mentioned, it is the object of the invention to enhance the flow of blood, and this is achieved by means of the support device, which will be explained with reference to FIGS. 1-3.

The support device, which is designated 1, comprises a plurality of cylinders 4, which are connected with a hydraulic circuit comprising pipes 5, as indicated in FIG. 5. Hydraulic pressure is applied to each cylinder 4 below the piston, so that all the pistons are in the highest position, such as e.g. in FIG. 1, in which, however, one cylinder B is lowered.

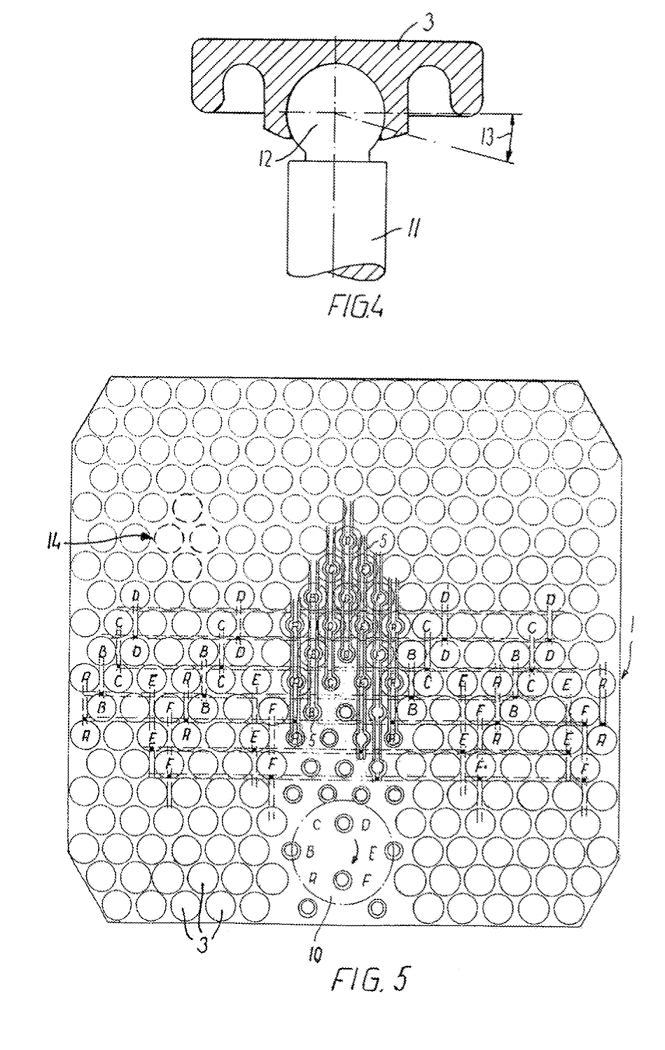

Each piston is provided with a piston rod which carries a pressure plate 3 at the top, as shown in FIG. 4. The joint between the pressure plate 3 and the piston rod 11 preferably comprises a snap-like coupling comprising a ball part 12, which is disposed on the uppermost end of the piston rod 11.

A ball recess is provided on the lower side of the pressure plate 3, and since the pressure plate 3 is made of a resilient material, the wall in the recess will be able to snap around the ball 12. In this manner, the pressure plate 3 will be able to tilt, as indicated by the angle 13, just as it may be removed, e.g. as shown in dashed line 14 in FIG. 5, in those cases where it might be necessary to avoid pressure impacts. This might be in the event that the user has or is likely to incur ulceration and the like.

In the example shown, a pad or a cover 2 extends above the pressure plates 3 in order to even out gaps between the pressure plates 3.

The drawing shows a section through a body part 8, which is the part of the body which is supported by the support device.

In FIG. 1, the pressure plate on cylinder B is lowered, while the other plates 3 are in their highest position. Therefore, the blood 9 will seep down to a point above the lowered pressure plate, as indicated by cross hatching.

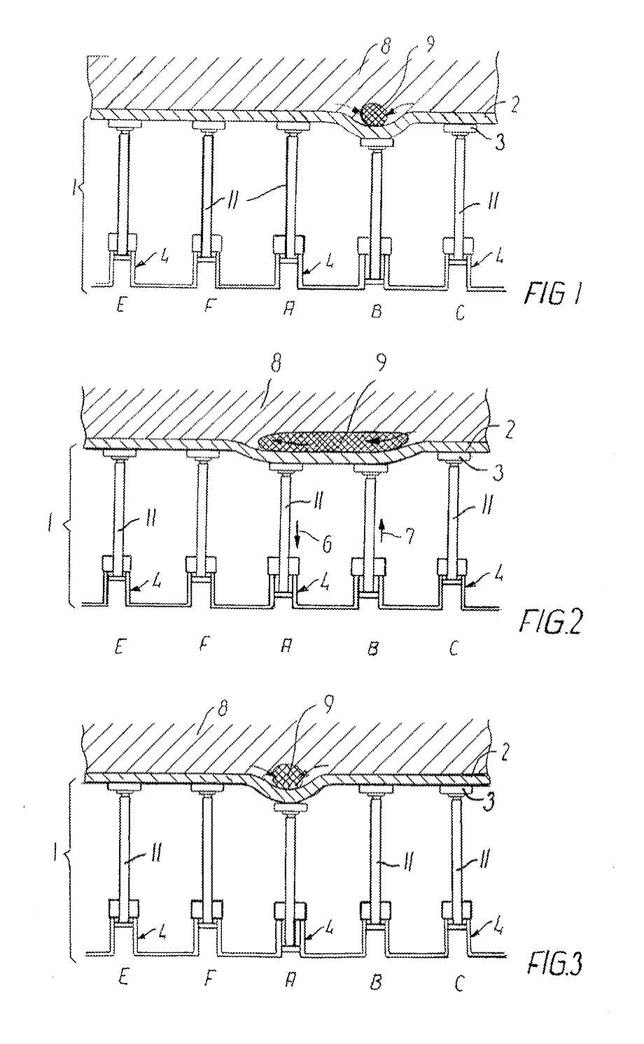

After a suitable period of time, a valve device, as shown in FIG. 5, will be switched to raise the lowered plate 3, as indicated by the arrow 7, and at the same time the adjacent cylinder A is lowered, as shown by the arrow 6 (see FIG. 2). This change will cause the blood 9 to be driven from the area above cylinder B to the adjacent area above the lowered cylinder A. The result of this is seen in FIG. 3, where the blood 9 has seeped across the pressure plate 3 on cylinder A and has thus changed places from a position above cylinder B to a position above cylinder A.

FIG. 5 shows an example of a valve device without a cover 2 in order to show the pressure plates 3 in the form of circles. As it has been attempted to illustrate, the cylinders are arranged in rows, and such that a set of cylinders marked A are arranged in straight lines at the side of a set of cylinders B at the one side and a set of cylinders F at the other side, thus six sets of cylinders in the example shown in FIG. 5. Each of these sets has e.g. 42 cylinders, which together form a support device having 252 movable pressure plates.

A distributor valve 10 having an inlet into and an outlet from the individual cylinders 4 ensures that hydraulic liquid under pressure is conveyed to all the cylinders, e.g. marked A, at the same time as hydraulic liquid is conveyed away from all the adjacent cylinders, e.g. marked B. This provides the desired effective flow of blood between adjacent support points, as the blood flows in a “closed” circuit, while adjacent pistons operate.

For instance, it is possible to use a distributor valve 10 in which the valve member is rotated stepwise by a stepping motor having a drive device, and where a pump distributes liquid out and in via outlet openings on the valve.

Thus, the function of the support device may be summarized as follows:

The pressure plates 3 with associated cylinders 4 are divided into sets with an equal number in each set, where one of the sets is always lowered.

When the set which has been lowered, e.g. set B in FIG. 1, is to be filled, this takes place in that the adjacent set A discharges its contents of hydraulic liquid to set B. During this function, sets A and B are not in hydraulic connection with the other sets C, D, E and F.

At the termination of the empty/fill function, set B will be connected with sets C, D, E and F, so that, as shown in FIG. 3, the user now sits or lies on sets B, C, D, E and F, which are interconnected and thereby give a total pressure equalization and simultaneously assume a shape which is completely adapted to the user's anatomy.

This entire process is controlled by a valve 10 and an associated pump unit (not shown).

By means of this equipment, any desired frequency of the movements of the cylinders and thereby of the flow of blood may be achieved by means of a simple and very operationally reliable appliance.

1. A support device in the form of a seat or a mattress for the establishment of a controlled flow of blood in a body part which rests on the support device, the support device comprising:
a plurality of vertically movable support elements disposed in the support device, said each support elements being in the form of a pressure plate mounted on a piston rod of a piston in a cylinder, to which a hydraulic liquid is supplied and discharged from the cylinder chamber to raise and lower the pressure plate, respectively, the support device (1) having a plurality of cylinders (4) which are interconnected (5) hydraulically in sets and wherein distribution of the hydraulic liquid is controlled by a valve (10) with pressure supply of hydraulic liquid for stepwise supply to and discharge of the hydraulic liquid from the individual sets (A-F) of cylinders (4) such that when one of the sets (A-F) of pressure plates (3) is lowered (6), an adjacent and previously lowered set of pressure plates (3) is raised (7).

2. A support device according to claim 1, characterized in that it moves the blood (9) in a “closed” circuit from a point on the body part (8) above a given pressure plate (3) to an adjacent point on the body part (8) above an adjacent pressure plate (3).

3. A support device according to claim 1, characterized in that it consists of e.g. six sets (A-F) of support elements, each set having 42 cylinders with pressure plates to form a support device (1) having 252 movable pressure plates (3).

4. A support device according to claim 1, characterized in that the pressure plate (3) is secured to the piston rod (11) by means of a snap-like joint.

5. A support device according to of claim 4, characterized in that the joint comprises a ball part (12) on the piston rod (11), around which a resilient ball-shaped depression on the lower side of the pressure plate (3) may grip.

6. A support device according to claim 1, characterized in that the pressure plate (3) is tiltable and may thereby conform to the body part (8).

7. A support device according to claim 1, characterized in that the pressure plate (3) is removably connected to the piston rod (11, 12).

8. A support device according to claim 2 characterized in that it consists of e.g. six sets (A-F) of support elements, each set having 42 cylinders with pressure plates to form a support device (1) having 252 movable pressure plates (3).

9. A support device according to claim 2, characterized in that the pressure plate (3) is secured to the piston rod (11) by means of a snap-like joint.

10. A support device according to claim 3, characterized in that the pressure plate (3) is secured to the piston rod (11) by means of a snap-like joint.

11. A support device according to of claim 9, characterized in that the joint comprises a ball part (12) on the piston rod (11), around which a resilient ball-shaped depression on the lower side of the pressure plate (3) may grip.

12. A support device according to of claim 10, characterized in that the joint comprises a ball part (12) on the piston rod (11), around which a resilient ball-shaped depression on the lower side of the pressure plate (3) may grip.
